(19) United States
(12) Patent Application Publication
(10) Pub. No.: US 2017/0018375 A1
(43) Pub. Date: Jan. 19, 2017

(54) Button Structure

(71) Applicant: COMPAL BROADBAND NETWORKS INC., Taipei City (TW)

(72) Inventors: Chiang-Chang Wu, Hsinchu County (TW); Cheng-Shan Lin, Hsinchu County (TW); Chung-Ming Pan, Hsinchu County (TW)

(21) Appl. No.: 15/012,870

(22) Filed: Feb. 2, 2016

Related U.S. Application Data
(60) Provisional application No. 62/193,099, filed on Jul. 16, 2015.

(30) Foreign Application Priority Data
Dec. 4, 2015 (TW) 104219475

(51) Int. Cl. H01H 3/12

(52) U.S. Cl. CPC H01H 3/12

(57) ABSTRACT

A button structure applied in an electronic device includes an up-cover having a pressing portion including a button base and a center column portion disposed on the button base, wherein the center column portion has a first limitation portion, the first limitation portion includes a first tilt side surface; and a second limitation portion disposed on the up-cover, wherein the second limitation portion forms a hole and includes a second tilt side surface surrounding the hole. The present invention utilizes the limitation portion of pressing portion and the limitation portion of the up-cover to limit the range of recovering displacement of the pressing portion.

### CROSS REFERENCE TO RELATED APPLICATIONS

This application claims the benefit of U.S. provisional application No. 62/193,099, filed on Jul. 16, 2015 and incorporated herein by reference.

### BACKGROUND OF THE INVENTION

1. Field of the Invention

The present invention relates to a button structure, and more particularly, to a button structure suitable for an electronic device with an inclined operational plane.

2. Description of the Prior Art

For the comfort and convenience of usage, appearance of electronic devices tends to be with an all-in-one and simple style, so as to be suitable for various work or residential environment. In such a situation, for an electronic device having an inclined operational plane, how to provide a button structure for the inclined operational plane on the electronic device with good convenience of usage is a significant objective in the field.

### SUMMARY OF THE INVENTION

It is therefore a primary objective of the present invention to provide a button structure suitable for an electronic device with an inclined operational plane.

An embodiment of the present invention discloses a button structure, applied in an electronic device including an up-cover, the button structure comprising a pressing portion comprising a button base and a center column portion, disposed on the button base, comprising a first limitation portion surrounding a terminal of the center column portion, wherein the first limitation portion comprises a first side surface, and the first side surface forms a first angle related to a first plane of the up-cover; and a second limitation portion, disposed on the up-cover, wherein the second limitation portion forms a hole and comprises a second side surface surrounding the hole, and the second side surface forms a second angle related to the first plane of the up-cover; wherein the center column portion is disposed in the hole, the second limitation portion surrounds the first limitation portion, and the first angle and the second angle are not equal to 90 degrees.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an appearance of an electronic device according to an embodiment of the present invention.

FIG. 2A is a schematic explosive diagram of a button structure according to an embodiment of the present invention.

FIG. 2B is a schematic diagram of a sectional side view of the button structure in FIG. 2A.

FIG. 3 is a schematic diagram of a pressing portion according to an embodiment of the present invention.

### DETAILED DESCRIPTION

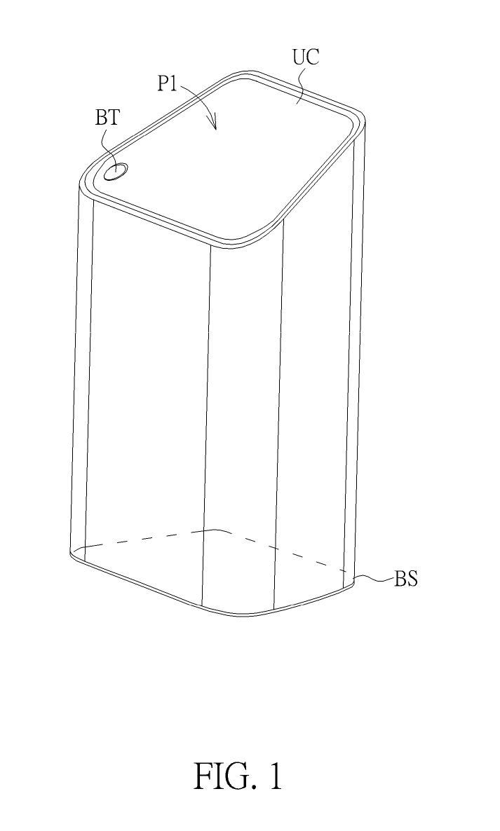

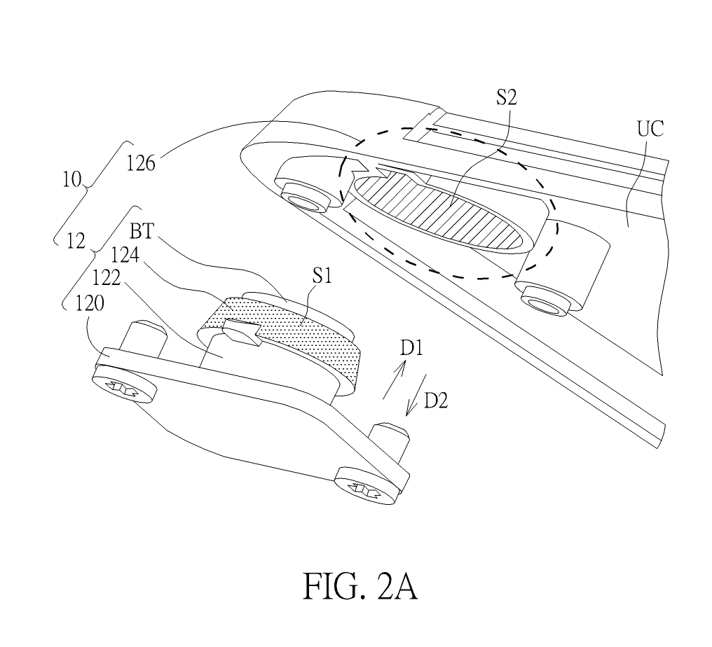

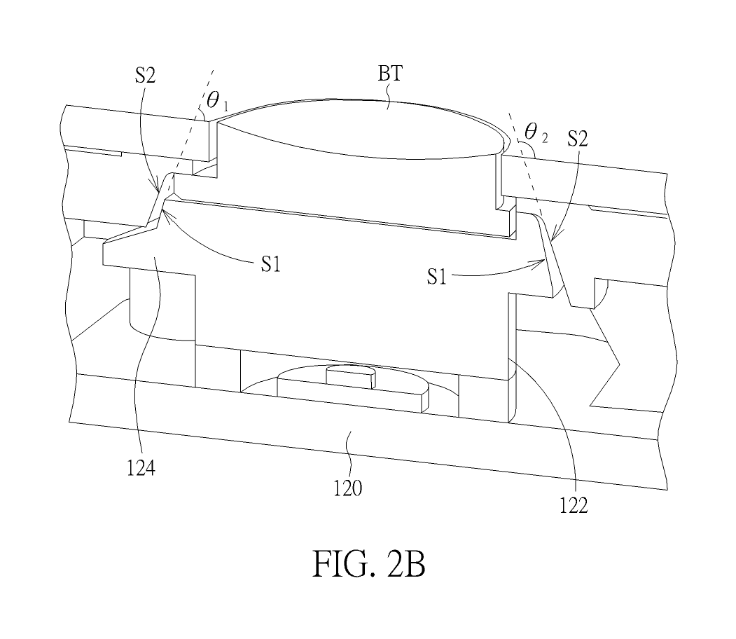

FIG. 1 is a schematic diagram of an appearance of an electronic device 1 according to an embodiment of the present invention. FIG. 2A is a schematic explosive diagram of a button structure 10 according to an embodiment of the present invention. FIG. 2B is a schematic diagram of a sectional side view of the button structure 10. The electronic device 1 comprises an up-cover UC and a base BS. The up-cover UC forms an inclination angle, with nonzero degrees, related to the base BS. In other words, a first plane P1 of the up-cover UC is not parallel to the base BS. The first plane P1 is regarded as an inclined operational plane of the electronic device 1. The button structure 10 comprises a pressing portion 12 and a limitation portion 126. The pressing portion 12 comprises a keycap BT, a button base 120 and a center column portion 122. The keycap BT appears on the first plane P1 of the up-cover UC, such that a user may press the keycap BT and perform operations on the electronic device 1 via the pressing portion 12. The center column portion 122 is constantly disposed on the button base 120. The center column portion 122 comprises a limitation portion 124. The limitation portion 124 forms as a ring surrounding a terminal of the center column portion 122. The limitation portion 124 comprises a first side surface S1. The first side surface S1 surrounds the limitation portion 124 obliquely. In other words, the first side surface S1 forms a first angle θ₁ related to the first plane P1 of the up-cover UC, and the first angle θ₁ is not equal to 90 degrees. On the other hand, the limitation portion 126 is disposed on the up-cover UC. The limitation portion 126 surrounds the limitation portion 124. The limitation portion 126 form a hole HL, such that the pressing portion 12 may penetrate through the hole HL of the limitation portion 126 such that the keycap BT appears on the first plane P1 of the up-cover UC. The hole HL includes a second side surface S2. The second side surface S2 also surrounds the hole HL obliquely. In other words, the second side surface S2 forms a second angle θ₂ related to the first plane P1 of the up-cover UC, and the second angle θ₂ is not equal to 90 degrees.

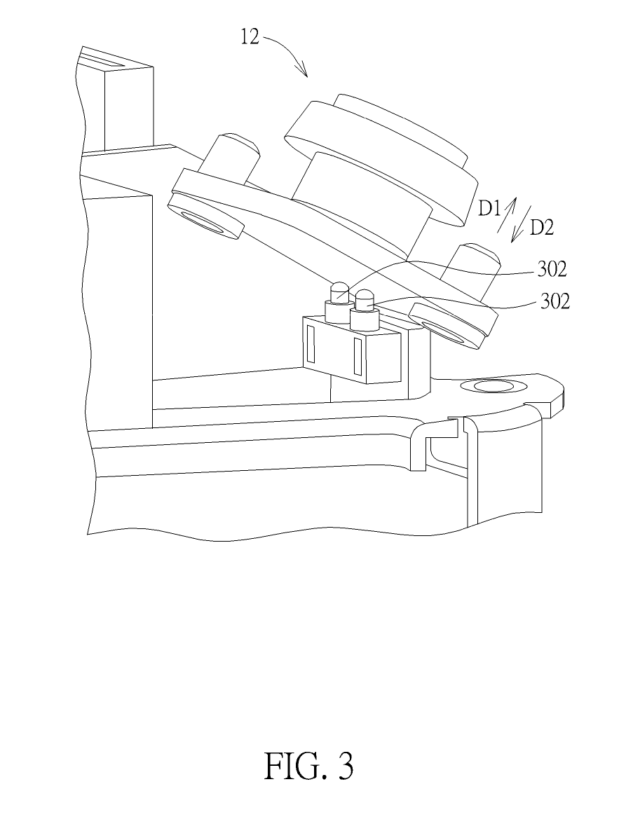

In an embodiment, the electronic device 1 may comprise pogo pins disposed under the pressing portion 12. For example, FIG. 3 partially illustrates the pressing portion 12 disposed within the electronic device 1 according to an embodiment of the present invention. As shown in FIG. 3, the button base 120 of the pressing portion 12 forms a specific angle, with nonzero degrees, related to the base BS of the electronic device 1. In addition, pogo pins 302 are disposed under the pressing portion 12. A structure of the pogo pin 302 is known by one skilled in the art, which is not narrated herein for brevity. In short, each of the pogo pins 302 comprises a spring therein (not illustrated in FIG. 3). When the user presses the pressing portion 12, the pogo pins 302 are shortened by an external force applied from the user. The pogo pins 302 generate electrical current to a circuit board of the electronic device 1. When the user stops pressing and releases the pressing portion 12, the spring within the pogo pin 302 generates a reaction force onto the pressing portion 12. At this time, the limitation portion 126 limits a range of recovering displacement of the pressing portion 12 caused by the reaction force. That is, after the reaction force is applied on the pressing portion 12 by the spring of the pogo pins 302, the pressing portion 12 is still within the hole HL of the limitation portion 126.

Preferably, a top of the limitation portion 124 is narrower than a bottom of the limitation portion 124 because of the first side surface S1, and a top of the limitation portion 126 is wider than a bottom of the limitation portion 126 because of the second side surface S2. In other words, since the first side surface S1 tilts as the first angle θ₁ and surrounds the limitation portion 124, a first diameter of the limitation portion 124 is smaller than a second diameter of the limitation portion 124; since the second side surface S2 tilts as the second angle θ₂ and surrounds the limitation portion 126, a third diameter of the limitation portion 126 is smaller than a fourth diameter of the limitation portion 124. The first diameter of the limitation portion 124 is a diameter of the limitation portion 124 in a first direction D1, the second diameter is a diameter of the limitation portion 124 in a second direction D2, the third diameter of the limitation portion 126 is a diameter of the limitation portion 126 in the first direction D1, and the fourth diameter of the limitation portion 126 is a diameter of the limitation portion 126 in the second direction D2. The first direction D1 is a direction from the button base 120 towards the first plane P1 of the up-cover UC, and the second direction D2 is an inverse direction of the first direction D1. Therefore, when the user stops pressing and releases the pressing portion 12 and the pressing portion 12 is forced by the spring within the pogo pin 302, the limitation portion 124 and the limitation portion 126 limit the range of recovering displacement of the pressing portion 12. In other words, the first side surface S1 of the limitation portion 124 and the second side surface S2 of the limitation portion 126 limit the pressing portion 12, such that the pressing portion 12 is still within the hole HL after the pressing portion 12 is forced by the reaction force generated by the spring within the pogo pin 302.

As can be seen from the above, for the electronic device 1 including the inclined operational plane, the present invention utilizes the first side surface S1 of the limitation portion 124 and the second side surface S2 of the limitation portion 126 to limit the range of recovering displacement of the pressing portion 12, which brings good limitation effect and convenience of usage.

Notably, the embodiments stated in the above are utilized for illustrating the concept of the present invention. Those skilled in the art may make modifications and alternations accordingly, and not limited herein. For example, in the button structure 10, the center column portion 122 is represented as a cylinder and the hole HL is represented as a circle, which is not limited herein. A shape of a section of the center column portion of the button structure and a shape of the hole may be any regular shape or irregular shape. As long as the limitation portion of the center column portion comprises the tilt side surface and the limitation portion on the up-cover comprises the tilt side surface correspondingly, the requirements of the present invention is satisfied, which is within the scope of the present invention.

In summary, the present invention utilizes the limitation portion of pressing portion and the limitation portion of the up-cover to limit the range of recovering displacement of the pressing portion, which brings good limitation effect and convenience of usage.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A button structure, applied in an electronic device including an up-cover, the button structure comprising:
a pressing portion, comprising:
a button base; and
a center column portion, disposed on the button base, comprising a first limitation portion surrounding a terminal of the center column portion, wherein the first limitation portion comprises a first side surface, and the first side surface forms a first angle related to a first plane of the up-cover; and
a second limitation portion, disposed on the up-cover, wherein the second limitation portion forms a hole and comprises a second side surface surrounding the hole, and the second side surface forms a second angle related to the first plane of the up-cover;
wherein the center column portion is disposed in the hole, the second limitation portion surrounds the first limitation portion, and the first angle and the second angle are not equal to 90 degrees.

2. The button structure of claim 1, wherein the button base forms a specific angle with nonzero degrees related to a base of the electronic device.

3. The button structure of claim 1, wherein the first side surface of the first limitation portion and the second side surface of the second limitation portion are configured to limit the pressing portion in the hole.

4. The button structure of claim 1, wherein a first diameter in a first direction of the first limitation portion is smaller than a second diameter in a second direction of the first limitation portion, a third diameter in the first direction of the second limitation portion is greater than a fourth diameter in the second direction of the second limitation portion, the first direction is from the button base towards the up-cover, and the second direction is an inverse direction of the first direction.

5. The button structure of claim 1, wherein the up-cover forms an inclination angle with nonzero degrees related to a base of the electronic device.
